(19) United States
(12) Patent Application Publication
(10) Pub. No.: US 2002/0100820 A1
(43) Pub. Date: Aug. 1, 2002

(54) Cooling apparatus for the cooling of overlapping wire rod rings

(75) Inventors: Wolfgang Berg, Hilchenbach (DE); Hermann Josef Eberts, Kirchhundem (DE); Gerhard Herzog, Muhlheim (DE); Karl Keller, Hilchenbach (DE); Uwe Plociennik, Ratingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: SMS DEMAG AKTIENGESELLSCHAFT

(21) Appl. No.: 10/055,623

(22) Filed: Jan. 22, 2002

(30) Foreign Application Priority Data
Jan. 27, 2001 (DE) 10103680.9

(51) Int. Cl. A62C 37/20

(52) U.S. Cl. 239/562

(57) ABSTRACT

A cooling apparatus for rolled wire rod has individual blowers for the outer and inner regions of the conveyor with speed control to insure a uniform cooling in spite of different mass along the outer and inner regions. A single controller may be provided for each motor or group of motors for each zone or some zones may be controlled and others not.

### FIELD OF THE INVENTION

The present invention relates to a cooling apparatus for the continuous cooling, on a conveyor, of the overlapping or shingled wire rod “rings” of rolled wire rod. More particularly, the invention relates to the blower construction for such a cooling apparatus so that the distribution of the cooling air can match the mass distribution of the rings to be cooled.

### BACKGROUND OF THE INVENTION

Hot-rolled wire rod arriving at high speed from the hot rod-cooling mill, is deposited by a laying cone in overlapping loops, referred to as “rings”, on the cooling conveyor which may be a roller conveyor. The overlapping rings on the roll conveyor are cooled by streams of cooling air which can pass through the rolls of the conveyor and contact the wire rod rings in overlapping relationship thereon. Because of the nature of the overlapping rings, the wire rod mass along the edges of the conveyor is greater per unit length of the conveyor than at the center or inwardly of the outer edges and it is important to carry out the cooling so that the cooling rate is uniform all across the conveyor and thus for all portions of the overlapping rings. A uniform cooling rate insures a uniform internal structure of the wire rod.

It has previously been proposed to provide below the conveyor plane a blower system which can direct the cooling air at different flow rates to compensate for the variation of the mass density over the width of the conveyor plane, thereby providing greater air flow rates in the edge regions than at the central region. This system is a rigid system since the flow rates along the edges and at the center of the path are fixed and cannot take into consideration differences in the cooling requirements which may arise from different cross sections of wire rod and different materials.

It has been proposed, moreover, to control the flow directions and thus the cooling effect of the cooling air utilizing baffles which can be angularly adjusted and thereby permit certain regions to have a greater cooling effect while other regions may have a reduced cooling effect. This approach, however, has required complex structures to be developed for the cooling line, creates the need for many movable elements and consequently, significant maintenance and repair costs and problems with respect to control of the uniformity of the cooling operation. In fact, in spite of the ability to effect some control, these systems have been found to have limited versatility and flexibility (see EP 0060227A2).

### OBJECTS OF THE INVENTION

It is the principal object of the present invention, therefore, to provide a cooling system for the laid down hot rolled wire rod rings on a conveyor, e.g. a roller conveyor, whereby the cooling action can be matched to the distribution of the mass of the product to be cooled on the conveyor but which is simpler, less prone to break down, more reliable and of greater flexibility than earlier systems.

Another object of the invention is to provide an apparatus for the purposes described which can be operated with lower maintenance costs than has hitherto been the case.

It is also an object of this invention to provide a cooling arrangement which allows the coils or rings of hot rolled wire rod to be efficiently cooled so as to obtain a uniform structure and thus so that different cooling flows are provided as required for uniform cooling in regions of different masses of the product to be cooled and with greater control, lower capital and operating costs greater reliability.

### SUMMARY OF THE INVENTION

These objects and others which will become apparent hereinafter are attained, in a cooling apparatus for wire rod, especially hot rolled wire rod laid down by a laying cone and which comprises;

a conveyor defining a path for overlapping rings of wire rod in a conveying plane;

respective guides directing separate cooling air streams onto the overlapping rings of wire over a predetermined portion of a length of the path at respective laterally outer regions and at least one laterally inner region of the path between the outer regions; and

respective independently controllable blowers connected with the guides for generating the air streams and including at least one of the blowers for producing at least one of the air streams at the outer regions and at least another of the blowers for producing the air stream at the inner region.

According to the invention, over a given length region of the conveyor, on the two outer regions and at the middle or central region respective cooling air streams are applied such that the cooling air streams are produced by separately controllable blowers. These blowers can be of the same type (size, construction) if desired, in which case the two blowers generating the air flows for the two outer regions will be operated at the same power whereas the blower for the middle region can be operated at a higher or lower power as may be required to obtain uniform cooling for the entire internal structure of the wire rod mass.

The drive motors for the blowers are preferably speed controllable and especially frequency controlled motors. Each of the drive motors of the blowers can be individually controlled or in individual control can be provided for the blower or blowers of the inner region while the cooling air streams for the outer regions can have a single controller so that the two motors for generating these streams may be controlled in common.

According to a further feature of the invention, individual control can be provided for the blower for the central region while the blowers for the outer regions need not be controlled at all. The two blowers for the outer region and the blower for the intermediate region can be mounted together in a single module of the conveyor which can have a number of such modules arranged in succession along the path.

The blast pipe from the blowers of the two outer regions can be located on opposite sides of the blast pipe of the blower for the central region and all of these blast pipes may open upwardly into a funnel shape diffuser directing the air onto the rings from the underside.

The blowers can be offset from one another across the width of the conveyor and in succession along the latter, i.e. in the transport direction and it has been found to be advantageous in some cases to provide slidable or swingable baffle plates to additionally guide or control the airflow.

The invention has the advantage that it can make use of commercial blowers and drive motors of a sample type and respective controls for them, thereby simplifying maintenance and replacement of the various units as may be necessary while insuring a uniform quality of the product by uniform cooling depending upon the mass concentration during the travelling of the wire rod along the conveyor.

### BRIEF DESCRIPTION OF THE DRAWING

The above and other objects, features, and advantages will become more readily apparent from the following description, reference being made to the accompanying drawing in which:

FIG. 1 is a diagrammatic side elevational view of a blower arrangement along a portion of a length of a conveyor adapted to transport the laid down wire rod rings of hot rolled wire rod for cooling;

FIG. 2 is a diagrammatic top plan view thereof, the view of FIG. 2 being taken along the lines II-II of FIG. 1;

FIG. 3 is a view similar to FIG. 1 but illustrating another embodiment of the invention;

FIG. 4 is a diagrammatic top plan view of the arrangement of the blowers of FIG. 3, the view of FIG. 4 being taken along the line IV-IV of FIG. 3;

FIGS. 5 through 10 are diagrams showing various motor drive systems for blowers used in the cooling of the wire rod rings according to the invention; and

FIG. 11 is a view similar to FIG. 1 partly broken away and illustrating other features of the invention.

### SPECIFIC DESCRIPTION

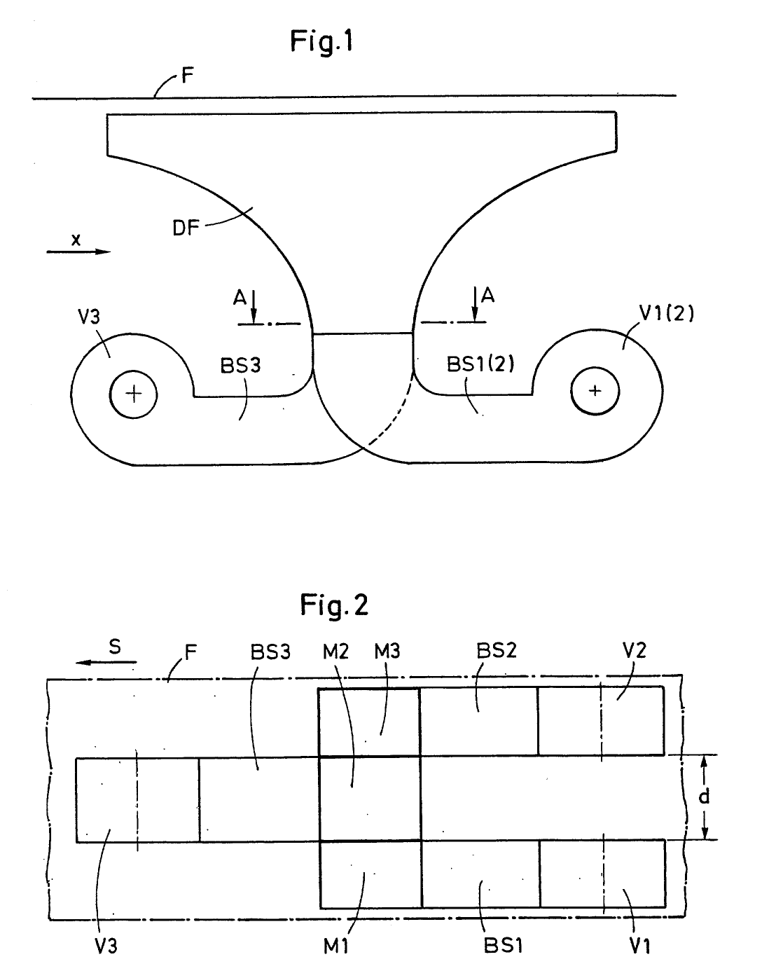

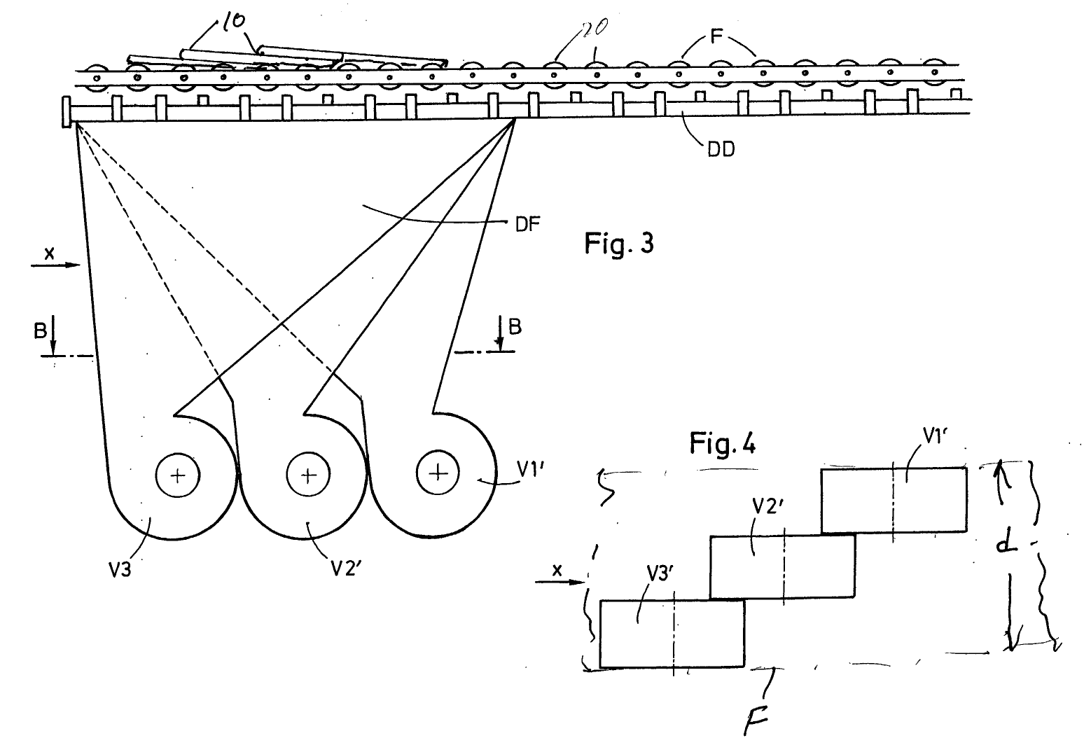

As can be seen from FIG. 1, a conveyor F, e.g. a roller conveyor as shown in FIG. 3, forms a horizontal plane along which rings of the rolled wire rod can be displaced for cooling. Such rings are shown at 10 in FIG. 3 and overlap when they are laid down by the laying cone. The blower system which trains cooling air upwardly through the roller conveyor can comprise an upwardly open funnel shaped diffuser DF with an upwardly widening cross section. Into the funnel diffuser DF blast tubes or pipes BS1 and BS2 of the blowers V1 and V2 open, these being spaced traversely to the direction represented by the arrow X which, in turn, can represent the transport direction for the rings along the conveyor. The blowers V1 and V2 are spaced apart by the documents d (FIG. 2) below the conveyor and their blast pipes BS1 and BS2 can open into the diffuser funnel DF at representative mouths M1 and M2.

Within the spacing d, a blower V3 is arranged whose blast pipe BS3 is located between the blast pipes BS1 and BS2 and which opens at M3 into the diffuser funnel DF. Within the diffuser funnel, above the mouths, baffle plates can be provided as has been shown diagrammatically in FIG. 11. These baffle plates 12 and 13 may be swingable by servomotors 14 and 15 or may be shiftable by a linear motor 16 as illustrated for the baffle plate 17 in FIG. 11.

The baffle plates permit the individual cooling air streams from the respective blowers to be more sharply directed to the outer regions and the middle region of the conveyor. In general, therefore, the flows from the blowers V1 and V2 will be directed to the outer regions while the flow from the blower V3 will be directed to the middle region.

As can be seen from FIG. 3, the blowers V1′, V2′ and V3′ need not be oriented as shown in FIGS. 1 and 2 with the mouths 1 and 3 straddling the mouth M2, but can be staggered in the direction x from one side to the other. The blowers are here offset from one to another in the width direction, i.e. transversely, as they are stepped along the conveyor in the direction of displacement. The mouths of the respective funnel shaped diffusers open at a nozzle deck DD disposed below the rolls 20 of the roller conveyor F. FIG. 4 shows the staggering within the width d of the conveyor F.

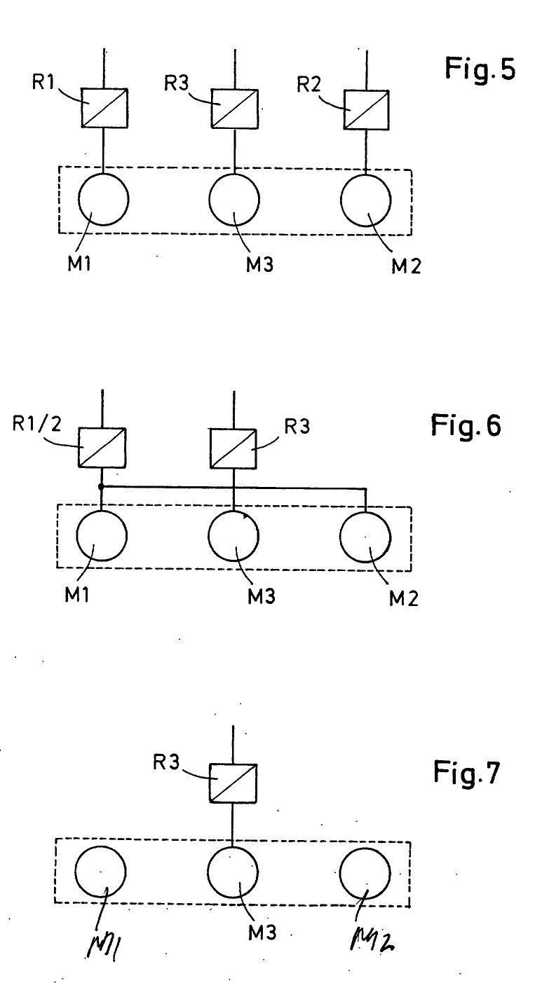

From FIG. 5 it can be seen that the drive motor 3 which is assigned to the blower V3 delivering the cooling air to the Ad central portion of the conveyor has a speed controller R3 while the motors M1 and M2 or the blowers V1 and V2 also have individual controllers R1 and R2. The motors M3 may all have frequency controlled variable speed motors and the controllers R1, R2 and R3 can be frequency generators or frequency converters with variable frequency outputs.

Alternatively (see FIG. 6) a single control R1/2 can regulate both of the motors M1 and M2 for the blowers V1 and V2 supplying the outer streams of cooling air while a controller R3 is individual to the motor M3 of the blower V3 supplying the intermediate flow of air.

A further alternative has been shown in FIG. 7 where the motors M1 and M2 operate at their nominal speeds and are not controlled while a single speed control R3 is provided for the motor M3 driving the blower V3 which supplies the cooling air to the central zone.

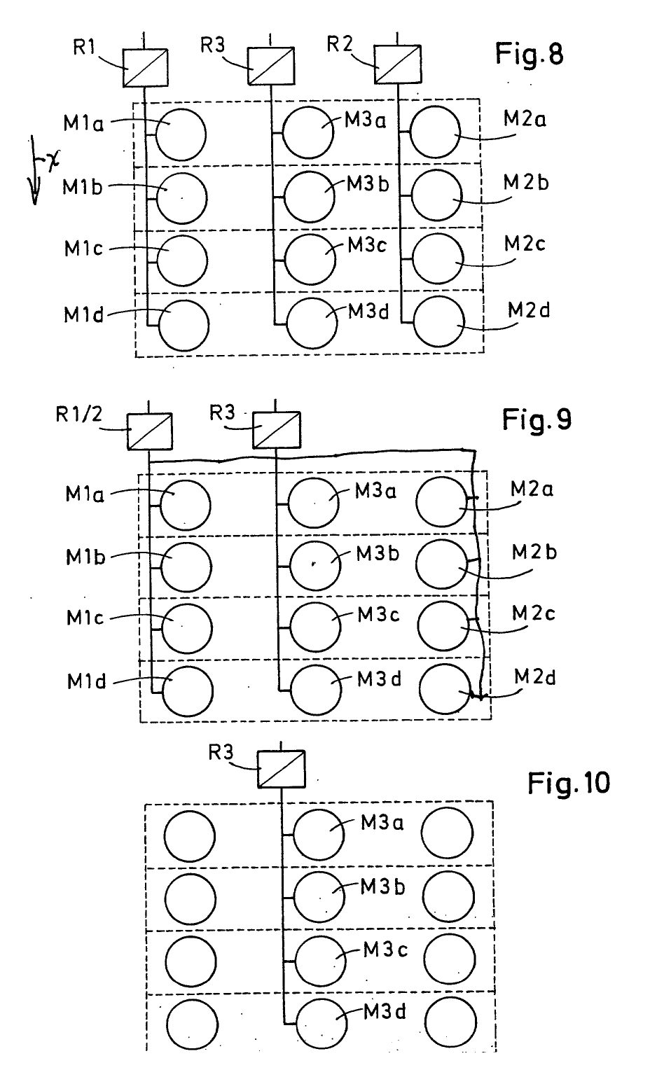

FIGS. 8, 9 and 10 correspond to the embodiments of FIGS. 5, 6 and 7 for the case in which a series of separate modules spaced along the conveyor each has a pair of outer blowers and an inner blower, the motors of which have been illustrated at M1a, M3a and M2a respectively. Other letter designations represents the successive modules and blowers and motors along the path represented by the arrow x in FIG. 8. In that case, the controls R1 and R2 regulate the speeds of all of the motors M1a, M1b, M1c, M1d and M2a, M2b, M2c, M2d along the outer sides of the conveyor and the speed controller and the speed controller R3 regulates the speed of the motor M3a to M3d in the central region.

By analogy to the embodiment of FIG. 6, the motors M1a through M1d and M2a through M2d are operated by the single control R1/2 while the controller R3 regulates the speeds M3a through M3d.

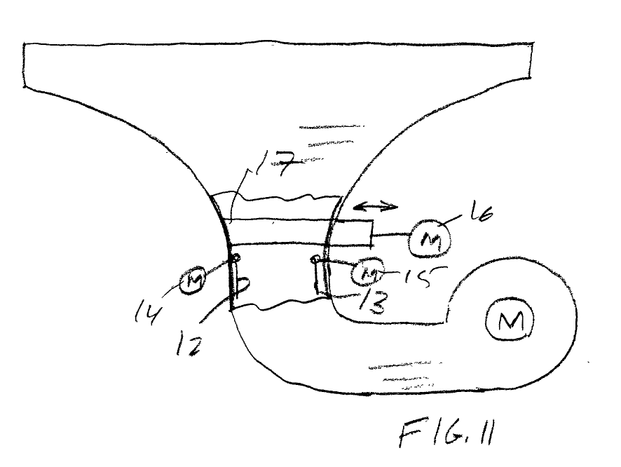

Finally with respect to the embodiments of FIGS. 7 and 10, it will be apparent that only the central row of motors M3a to M3d has a speed controller R3, the remaining motors being operated at their nominal speeds without regulation.

We claim:

1. A cooling apparatus for wire rod comprising:
a conveyor defining a path for overlapping rings of wire rod in a conveying plane;
respective guides directing separate cooling air streams onto said overlapping rings of wire over a predetermined portion of a length of said path at respective laterally outer regions and at least one laterally inner region of said path between said outer regions; and
respective independently controllable blowers connected with said guides for generating said air streams and including at least one of said blowers for producing at least one of the air streams at said outer regions and at least another of said blowers for producing the air stream at said inner region.

2. The cooling apparatus defined in claim 1 wherein respective outer blowers generate the air streams for said outer regions and an inner blower generates the air stream for said inner region, the outer blowers being of the same type and having substantially the same volumetric flow capacities and power, said inner blower having a greater or lesser power than that of said outer blowers.

3. The cooling apparatus defined in claim 1 wherein said blowers have respective controlled-speed electric motors.

4. The cooling apparatus defined in claim 3 wherein said motors are frequency-control motors connected to at least one frequency controller.

5. The cooling apparatus defined in claim 3 wherein each of said motors has a respective speed controller individual thereto.

6. The cooling apparatus defined in claim 3 wherein the motor of said inner blower has a respective speed controller individual thereto and the motors of said outer blowers have a common speed controller.

7. The cooling apparatus defined in claim 2 said inner blower has an electric motor controllable individually for regulating a speed thereof and said outer blowers have respective drive motors without speed controllers.

8. The cooling apparatus defined in claim 2 wherein the outer blowers and a respective inner blower are mounted together in a respective module of said conveyor, said conveyor having a succession of said modules disposed along said path.

9. The cooling apparatus defined in claim 2 wherein all of said blowers are disposed below said conveyor, said outer blowers have blast pipes spaced transversely apart across said conveyor and said inner blower has a blast pipe received between the blast pipes of said outer blowers, all of said blast pipes opening into a funnel-shaped diffuser widening upwardly toward said rings on said conveyor.

10. The cooling apparatus defined in claim 9 wherein said blowers are transversely offset by respective blower widths from one another along said path.

11. The cooling apparatus defined in claim 9, further comprising swingable baffle plates for said blast pipes.

12. The cooling apparatus defined in claim 9, further comprising slidable baffle plates for said blast pipes.
